(19) United States
(12) Patent Application Publication
(10) Pub. No.: US 2025/0010290 A1
(43) Pub. Date: Jan. 9, 2025

(54) MICROFLUIDIC DEVICE AND MICROFLUIDIC DETECTION DEVICE

(71) Applicant: BGI SHENZHEN, SHENZHEN, GUANGDONG (CN)

(72) Inventors: Zhentao ZHAO, SHENZHEN, GUANGDONG (CN); Yuning ZHANG, SHENZHEN, GUANGDONG (CN); Yuxiang LI, SHENZHEN, GUANGDONG (CN); Quanxin YUN, SHENZHEN, GUANGDONG (CN); Yuliang DONG, SHENZHEN, GUANGDONG (CN); Wenwei ZHANG, SHENZHEN, GUANGDONG (CN); Xun XU, SHENZHEN, GUANGDONG (CN)

(21) Appl. No.: 18/711,641

(22) PCT Filed: Dec. 10, 2021
(86) PCT No.: PCT/CN2021/137127

§ 371 Date: May 20, 2024

(51) Int. Cl. B01L 3/00

(52) U.S. Cl. CPC B01L 3/502715; B01L 3/502738; B01L 2200/027; B01L 2200/0684; B01L 2200/0689; B01L 2300/0627; B01L 2400/06

(57) ABSTRACT

A microfluidic device and a microfluid detection device, comprising a body (100) and a liquid channel (201) provided within the body (100); a fluid input port (103) communicated with the liquid channel (201) is also provided on the body (100), and an arrangement position of the fluid input port (103) does not include a sensing area (301). The microfluidic device and the microfluidic detection device are easy to operate, and can effectively solve the problem of introducing bubbles due to directly opening a liquid injection hole on the sensing area (301).

### TECHNICAL FIELD

This application relates to the technical field of microfluidic, and in particular, to a microfluidic device and a microfluidic detection device.

### BACKGROUND

Microfluidic technology is a technology that controls, operates, and detects complex fluids at microscopic dimensions and is a new interdisciplinary discipline developed on the basis of microelectronics, micromachines, bioengineering, and nanotechnology. In scientific experiments, such as biology, chemistry, and materials, etc., it is often necessary to operate fluids, wherein operations, such as the preparation of sample DNA, liquid chromatography, PCR reaction, electrophoresis detection, etc., are all carried out in a liquid-phase environment.

If steps, such as sample preparation, biochemical reaction, and result detection, etc., are to be integrated onto a biochip, the amount of fluid used in the experiment will usually be reduced from milliliter level to microliter level, and then a specialized microfluidic device is required to meet operational needs. Microfluidic devices have the advantages of light volume, small usage amount of a sample/reagent, and fast reaction speed, etc., and are widely used in biotechnology research.

However, microfluidic devices in the prior art usually require opening a liquid injection hole (i.e. 33 in FIGS. 1a and 1b) on a sensing region for adding a reagent or sample, which is easy to introduce bubbles in the sensing region and is not easy to operate.

In view of this, this application is proposed.

### SUMMARY

This application provides a microfluidic device and a microfluidic detection device to solve the problem of introducing bubbles due to opening a liquid injection hole on a sensing region in microfluidic devices in the prior art.

In order to solve the above problem, improve the integration of biomolecule detection device, and reduce the size of the detection device, this application adopts the following solution:

A microfluidic device comprises a body and a liquid channel provided within the body;
a sensing area is provided on the body;
a fluid input port communicated with the liquid channel is also provided on the body, and an arrangement position of the fluid input port does not include the sensing area.

In this solution, the microfluidic device comprises a body and a liquid channel provided inside of the body, a sensing area is provided on the body, and the liquid within the sensing area can be sensed as needed; a fluid input port communicated with the liquid channel is also provided on the body, and an arrangement position of the fluid input port does not include the sensing area, that is, the fluid input port is not provided directly on the sensing area, wherein the liquid to be detected enters the liquid channel from the fluid input port and flows into the sensing area to be sensed, which is easy to operate and can effectively solve the problem of introducing bubbles due to directly opening a liquid injection hole on a sensing region.

In a further preferred solution, the body is also provided with an on-off device, and the on-off device is used to control flow and interruption of liquid within the liquid channel. The on-off device is used to interrupt the liquid within the liquid channel to stop the flow of the liquid, thereby ensuring that the liquid within the sensing area is continuously and stably sensed, improving the sensing efficiency.

In a further preferred solution, a flow channel which can be communicated with the liquid channel is provided within the on-off device; the on-off device controls whether the flow channel and the liquid channel are communicated with each other by moving relative to the body. When the on-off device is adjusted so that the two ends of the flow channel within the on-off device are communicated with the liquid channel, the liquid flows normally; when the two ends of the flow channel within the on-off device are not communicated with the liquid channel, at this time, the on-off device will interrupt the liquid within the liquid channel.

In a further preferred solution, at least one hollow sealed chamber is also provided within the body, and a top of at least one sealed chamber is provided with a flowing-through membrane, and the sealed chamber and the liquid channel share the flowing-through membrane. The liquid within the sealed chamber and the liquid within the liquid channel are independent of each other, and ion transmission or signal transmission in other forms between the two liquids can be realized via the flowing-through membrane.

In a further preferred solution, at least one liquid passing port is also provided on the body, and the liquid passing port is communicated with the sealed chamber. The sealed chamber can be filled with liquid via the liquid passing port, and the number of the liquid passing port can be adjusted as needed.

In a further preferred solution, a bottom of the sealed chamber is provided with a sealing component or a conductive component, the conductive component is used to transmit electrical signals, and the sealing component is mainly used to seal the bottom of the sealing chamber.

In a further preferred solution, the sealed chamber at least comprises a cavity A and a cavity B that are communicated with each other, and at least one liquid passing port for feeding or discharging liquid is provided respectively above the cavity A and the cavity B, wherein the two liquid passing ports cooperate with each other and do not interfere with each other.

In a further preferred solution, the conductive component is provided at a bottom of the cavity A for transmitting electrical signals to the outside.

In a further preferred solution, the flowing-through membrane is provided at a top of the cavity B, and a bottom of the cavity B is provided with the sealing component. The flowing-through membrane is used to realize ion transmission or signal transmission in other forms between the liquid within the cavity B and the liquid within the liquid channel; the sealing component is used to seal the bottom of the cavity B to prevent liquid from seeping out.

In a further preferred solution, the cavity A has a fusiform structure and is located on one side of the liquid channel, the cavity B is arranged below the liquid channel, and a tip of the cavity A opposite to the liquid channel is communicated with the cavity B. The cavity B is arranged below the liquid channel, the cavity B can realize signal transmission with the liquid channel via the flowing-through membrane provided on its top, and the tip of the cavity A is communicated with the cavity B, forming a sealed area as a whole and enabling the liquid storage capacity of the sealing area to be expanded to a certain extent.

In a further preferred solution, a fluid storage device is provided at the fluid input port in a cooperation and communication manner, a top end of the fluid storage device opens an opening, and a bottom end of the fluid storage device is communicated with the fluid input port. Since the fluid input port of the microfluidic device is usually small in size and it is inconvenient to add liquid directly through the fluid input port, in this solution, the fluid storage device can be used as a liquid adding device with a larger top end opening, which facilitates adding liquid.

In a further preferred solution, the fluid storage device is detachably provided to the body, and an interior of the fluid storage device has a funnel-type structure. The fluid storage device is detachably provided to the body to facilitate installation, disassembly and replacement, and the interior of the fluid storage device is a funnel-type structure, with a wider top and a narrower bottom, which facilitates filling the liquid.

In a further preferred solution, an area on the body corresponding to the position of the sensing area is transparent, thereby facilitating observing the state of the liquid within the sensing area.

In a further preferred solution, the body is also provided with a collection area inside, the collection area is communicated with a rear end of the liquid channel, and a liquid discharge port is opened above the collection area. After the liquid within the liquid channel is sensed, it can enter the collection area to be collected, and when the volume of the liquid within the collection area is greater than the volume of the collection area, the liquid can be discharged from the collection area through the liquid discharge port to achieve a function of cyclic collection.

In a further preferred solution, the collection area has a spiral or serpentine structure. The spiral or serpentine structure can effectively increase the volume of the collection area, facilitating the collection of more liquid.

In a further preferred solution, the body comprises an upper plate and a lower plate that are connected to each other, and the liquid channel is a cavity formed between the upper plate and the lower plate;
wherein a bottom of the liquid channel is a portion of an upper surface of the lower plate, and a top of the liquid channel is a portion of a lower surface of the upper plate. The liquid channel is formed by the special structures of the upper plate and the lower plate, making full use of resources, and the structures of the upper plate and the lower plate also play an important role in the entire microfluidic device.

In a further preferred solution, an area of the upper plate corresponding to the position of the sensing area is recessed toward the lower plate, facilitating observing the state of the liquid within the sensing area; an area of the lower plate corresponding to the position of the sensing area is hollowed-out, and the hollowed-out area is used for external connection with a sensing device.

In a further preferred solution, an air vent is also provided above the collection area. A negative pressure device can be externally connected at the air vent to draw the liquid within the fluid storage device into the liquid channel and into the sensing area by applying negative pressure.

In a further preferred solution, a control valve is provided between the fluid input port and the fluid storage device, and the control valve is used to control whether the fluid input port and the fluid storage device are communicated. When the control valve is open, the fluid input port is communicated with the fluid storage device, and at this time, liquid can be filled directly via the fluid storage device.

This solution also provides a microfluidic detection device comprising the above microfluidic device, and the microfluidic detection device further comprises:
a sensing device connected to the body and corresponding to the sensing area,
wherein the sensing device has an overlapping portion with the liquid channel and can allow the liquid within the liquid channel to flow through it.

In this solution, the sensing device corresponds to the hollowed-out position of the sensing area, and the sensing device has an overlapping portion with the liquid channel, so the liquid located within the sensing area can be sensed with the sensing device.

In a further preferred solution, a sealing element is provided between the sensing device and the body. The arrangement of the sealing element can effectively avoid liquid leakage at the connection between the sensing device and the body.

In a further preferred solution, the sensing device is detachably connected with the lower plate; and the sealing element is detachably connected with the sensing device. Adopting a detachable connection way facilitates the installation and disassembly of the sensing device.

In a further preferred solution, the sensing device comprises a carrier plate, and
a sensing chip provided above the carrier plate, wherein the sensing chip corresponds to the liquid channel within the sensing area. During use, the liquid within the liquid channel will flow through the upper surface of the sensing chip, and then be sensed by the sensing chip; the carrier plate mainly plays the role of supporting and fixing the sensing chip, and the carrier plate and the sensing chip are combined to form the entire sensing device.

In a further preferred solution, the sealing element is a sealing sheet, and a through hole is opened in the sealing sheet, wherein the liquid channel and the sensing chip are communicated via the through hole. A through hole is opened in the sealing sheet, and liquid can flow into the through hole and reach the surface of the sensing chip to be sensed, wherein the sensing area can be effectively sealed by the sealing sheet.

In a further preferred solution, a cross-sectional area of the through hole is smaller than an upper surface area of the sensing chip, and edges of the through hole are located above the sensing chip. It is ensured that the through hole is completely located above the sensing chip, that is, the liquid within the through hole only contacts the upper surface of the sensing chip and can be fully sensed.

Compared with the prior art, this application has the following beneficial effects:
a microfluidic device provided by this application comprises a body and a liquid channel provided inside of the body, a sensing area is provided on the body, a fluid input port is not provided directly on the sensing area, the liquid within the sensing area can be sensed as needed, and the liquid to be detected enters the liquid channel from the fluid input port and flows into the sensing area to be sensed, which is easy to operate and can effectively solve the problem of introducing bubbles due to directly opening a liquid injection hole on a sensing region.

This application also provides a microfluidic detection device comprising the above microfluidic device, which can be directly used to sense the liquid to be detected, and is easy to operate and highly practical.

### BRIEF DESCRIPTION OF DRAWINGS

To describe the technical solutions in the embodiments of this application or in the prior art more clearly, the following will briefly describe the drawings required for describing the embodiments or the prior art. Apparently, the drawings described below are merely some embodiments of this application, and ordinary persons skilled in the art may still derive other drawings from these drawings without creative efforts.

FIGS. 1a and 1b are schematic structural views of existing microfluidic devices described in the Background;

FIG. 2 is a specific schematic structural view of a microfluidic device according to this application;

FIG. 3 is a schematic cross-sectional view taken along line A-A in FIG. 2;

FIG. 4 is a specific structural exploded view of a microfluidic detection device according to this application;

FIG. 5 is a structural exploded view of a microfluidic detection device according to this application from another view;

FIG. 6 is another specific schematic structural view of a microfluidic device according to this application;

FIG. 7 is a schematic cross-sectional view taken along line B-B in FIG. 6;

FIG. 8 is a schematic structural view of a flow channel of an on-off device and a liquid channel being in an interruption state according to this application;

FIG. 9 is a schematic cross-sectional view taken along line C-C in FIG. 8;

FIG. 10 is a schematic structural enlarged view of the on-off device in FIG. 9;

FIG. 11 is a schematic structural view of the flow channel of an on-off device and a liquid channel being in a communicated state according to this application;

FIG. 12 is a schematic cross-sectional view taken along line D-D in FIG. 11;

FIG. 13 is a schematic structural enlarged view of the on-off device in FIG. 11;

FIG. 14 is a schematic structural view of a collection area according to this application;

FIG. 15 is another schematic structural view of a collection area according to this application.

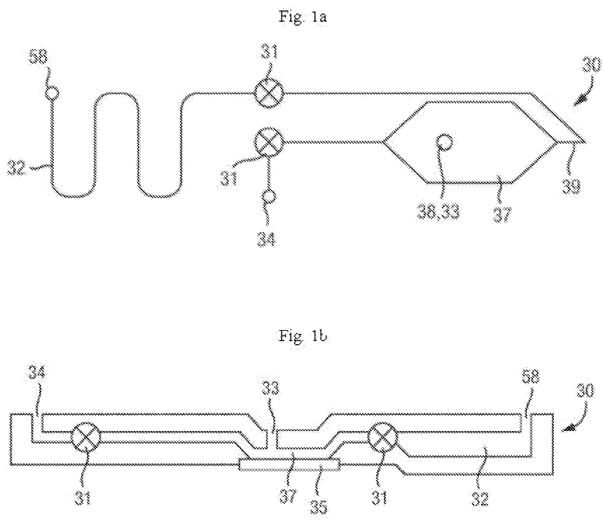

In the above drawings, the components represented by respective reference numbers are listed as follows:
body—100; upper plate—101; lower plate—102; fluid input port—103; on-off device—104; fluid storage device—105; collection area—106;
liquid channel—201;
sensing area—301;
sealed chamber—400; cavity A—4001; cavity B—4002; liquid passing port—401; flowing-through membrane—402; sealing component—403; conductive component—404;
sensing device—500; carrier plate—501; sensing chip—502; sealing element—503;
liquid discharge port—601; air vent—602.

### DESCRIPTION OF EMBODIMENTS

In order to make the above and other features and advantages of this application more clearly, this application is further described below in conjunction with the drawings. It should be understood that the specific embodiments given herein are for the purpose of explanation to those skilled in the art, only illustrative and not restrictive.

In the description of this application, it is to be understood that orientation or position relationships indicated by terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise” are orientation or position relationships shown on the basis of the drawings, and it is not intended to indicate or imply that the referred device or element must be at the specific orientation or be constructed and operated at the specific orientation, but only intended for the convenience of describing this application and simplifying the description, and thus such orientation or position relationships may not be understood as limits to this application.

In addition, terms “first” and “second” are only adopted for the objective of description, and may not be understood to indicate or imply relative importance of the indicated technical feature or implicitly indicate the number of the indicated technical feature. Therefore, a feature limited by “first” or “second” may explicitly or implicitly comprise at least one such feature. In the description of this application, unless otherwise explicitly and specifically limited, “a plurality of” means at least two, such as two, three, etc.

In this application, unless otherwise explicitly specified and limited, terms such as “mount”, “connect”, “connection” and “fix” should be broadly understood, for example: they may refer to a fixed connection, and may also refer to a detachable connection or being integrated; they may refer to a mechanical connection or may also refer to an electrical connection; they may refer to a direct connection, or may also refer to an indirect connection through an intermediate; they may refer to communication inside two elements or interaction relationship of two elements, unless otherwise explicitly specified and limited. For those of ordinary skill in the art, the specific meanings of the above terms in this application may be understood according to actual conditions.

In this application, unless otherwise explicitly specified and limited, a first feature is “over” or “under” a second feature, which can be a direct contact between the first and second features, or an indirect contact between the first and second features through an intermediate. Moreover, a first feature is “over”, “above” or “on top of” a second feature, which can be that the first feature is directly above or obliquely above the second feature, or only represents that the horizontal height of the first feature is larger than that of the second feature. A first feature is “under”, “below” or “underneath” a second feature, which can be that the first feature is directly below or obliquely below the second feature, or only represents that the horizontal height of the first feature is smaller than that of the second feature.

In the description of this specification, the description with reference to the terms “one embodiment”, “some embodiments”, “example”, “specific example”, or “some examples” or the like means that a particular feature, structure, material, or characteristic described in connection with the embodiment or example is comprised in at least one embodiment or example of this application. In this specification, exemplary description of the above terms is not necessarily referring to the same embodiment or example. Furthermore, the particular features, structures, materials, or characteristics described may be combined in a suitable manner in any one or more embodiments or examples. In addition, those skilled in the art may combine and incorporate different embodiments/examples or features of different embodiments/examples described in this specification unless they are inconsistent with each other.

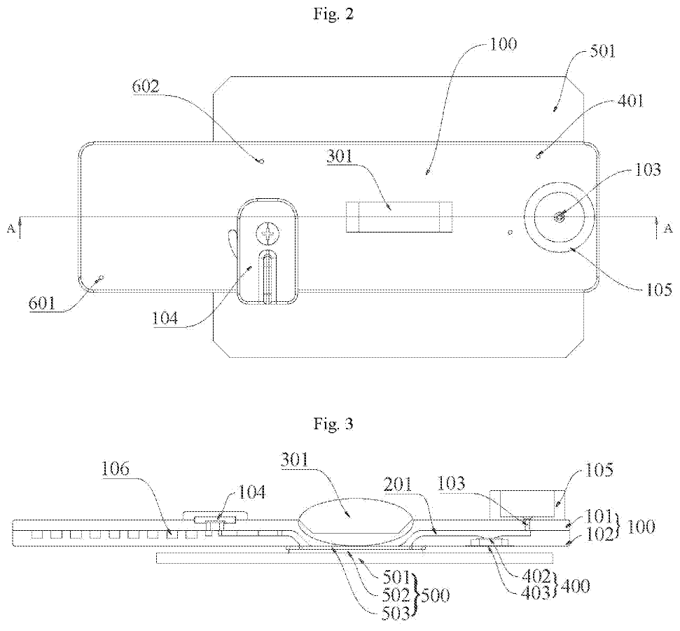

Please refer to FIGS. 2-7. This application provides a microfluidic device, and it comprises a body 100 and a liquid channel 201 provided within the body 100; a sensing area 301 is provided on the body 100; a fluid input port 103 communicated with the liquid channel 201 is also provided on the body 100, and an arrangement position of the fluid input port 103 does not include the sensing area 301.

In this solution, the microfluidic device comprises a body 100 and a liquid channel 201 provided inside of the body 100, a sensing area 301 is provided on the body 100, the liquid within the liquid channel 201 can flow through the sensing area 301, and the liquid within the sensing area 301 can be sensed as needed; a fluid input port 103 communicated with the liquid channel 201 is also provided on the body 100, and an arrangement position of the fluid input port 103 does not include the sensing area 301, that is, the fluid input port 103 is not provided directly on the sensing area 301, which can effectively solve the problem of introducing bubbles due to directly opening a liquid injection hole on a sensing region.

Further, the body 100 is also provided with an on-off device 104, and the on-off device 104 is used to control flow and interruption of the liquid within the liquid channel 201. The on-off device 104 is used to interrupt the liquid within the liquid channel 201 to stop the flow of the liquid, thereby ensuring that the liquid within the sensing area 301 is continuously and stably sensed, improving the sensing efficiency.

It should be noted that the on-off device 104 is mainly used to control the flow and interruption of the liquid within the liquid channel 201, and its specific structure and working principle are not limited here.

Further, a flow channel which can be communicated with the liquid channel 201 is provided within the on-off device 104; the on-off device 104 controls whether the flow channel and the liquid channel 201 are communicated with each other by moving relative to the body 100. When the on-off device 104 is adjusted so that the two ends of the flow channel within the on-off device 104 are communicated with the liquid channel 201, the liquid flows normally; when the two ends of the flow channel within the on-off device 104 are not communicated with the liquid channel 201, at this time, the on-off device 104 will interrupt flow of the liquid within the liquid channel 201. In this solution, the way for the on-off device 104 moving relative to the body 100 is not specifically limited, for example, it can be a translational movement or a rotary movement.

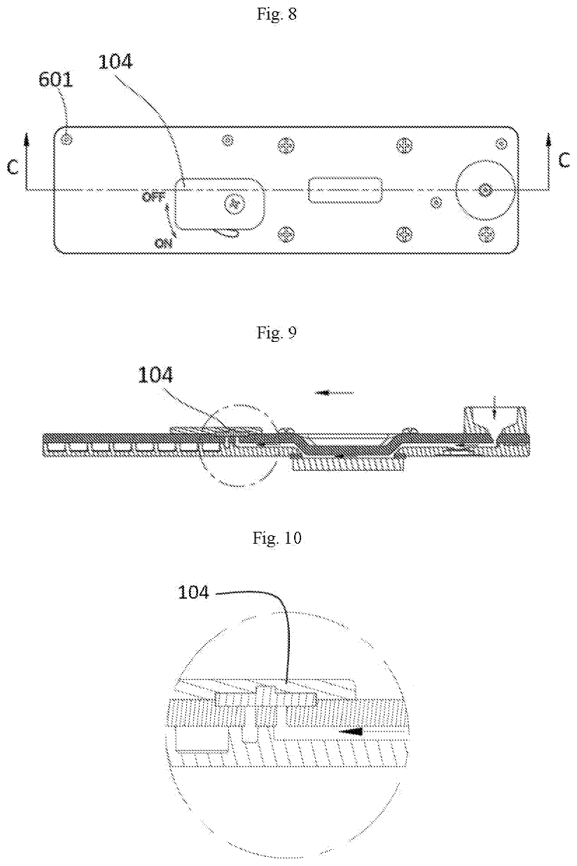

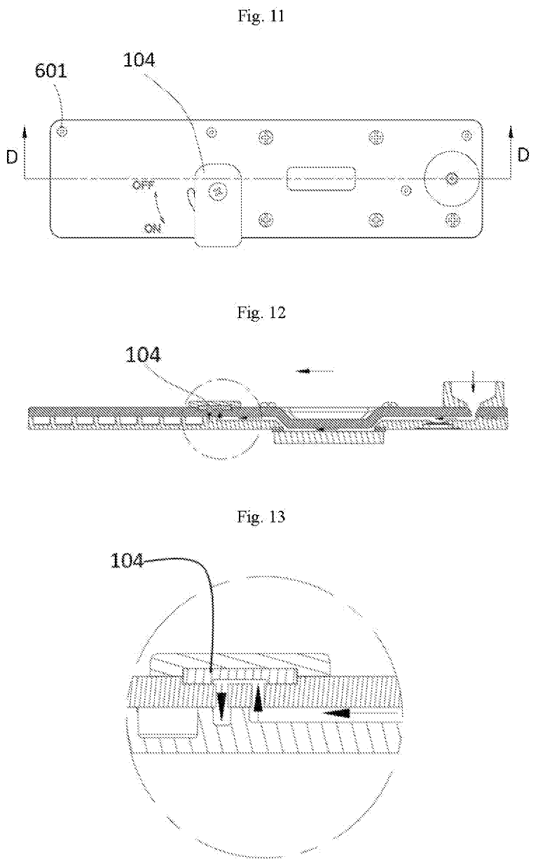

In another preferred embodiment, the on-off device 104 is a rotary valve, a flow channel which can be communicated with the liquid channel 201 is provided within the rotary valve, and whether the flow channel and the liquid channel 201 are communicated with each other is controlled by rotating the rotary valve. As shown in FIGS. 8-10, when the rotary valve is in an “OFF” state, the flow channel and the liquid channel 201 are in a disconnected state, and at this time, the liquid within the sensing area 301 can be sensed continuously and stably; as shown in FIGS. 11-13, when the rotary valve is in an “ON” state, the flow channel and the liquid channel 201 are in a communicated state, and at this time, the liquid within the liquid channel 201 can flow through the flow channel smoothly and enter a collection area 106 to be collected.

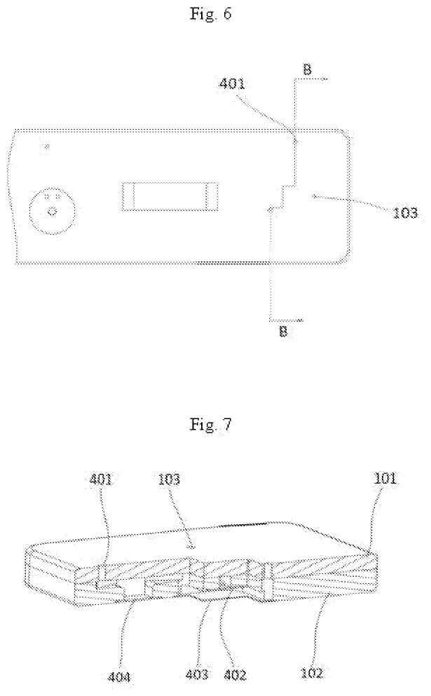

Further, as shown in FIGS. 6 and 7, at least one hollow sealed chamber 400 is also provided within the body 100, and a top of at least one sealed chamber 400 is provided with a flowing-through membrane 402, and the sealed chamber 400 and the liquid channel 201 share the flowing-through membrane 402, that is, the sealed chamber 400 and the liquid channel 201 are separated into two independent spaces by the flowing-through membrane 402. The liquid within the sealed chamber 400 and the liquid within the liquid channel 201 are independent of each other, and ion transmission or signal transmission in other forms between the liquid within the sealed chamber 400 and the liquid within the liquid channel 201 can be realized via the flowing-through membrane 402. The specific structure and material of the flowing-through membrane 402 are not limited here, and the flowing-through membrane 402 can be made according to actual functional needs. For example, in some cases, the flowing-through membrane 402 can adopt a semipermeable membrane.

It should be understood that the sealed chamber 400 in this solution only needs to be arranged between the on-off device 104 and the fluid input port 103, and can be arranged upstream or downstream of the sensing area 301.

Further, at least one liquid passing port 401 is also provided on the body 100, and the liquid passing port 401 is communicated with the sealed chamber 400. The sealed chamber 400 can be filled with liquid via the liquid passing port 401, and the number of the liquid passing port 401 can be adjusted as needed. The liquid passing port 401 in this solution can be used to fill the sealed chamber 400 with liquid, and can also be used as a discharge channel for the liquid within the sealed chamber 400.

Further, as shown in FIG. 7, a bottom of the sealed chamber 400 is provided with a sealing component 403 or a conductive component 404, the conductive component 404 is used to transmit electrical signals and its specific form and arrangement position are not limited in this embodiment, and the sealing component 403 is mainly used to seal the bottom of the sealing chamber 400 to prevent liquid from seeping out.

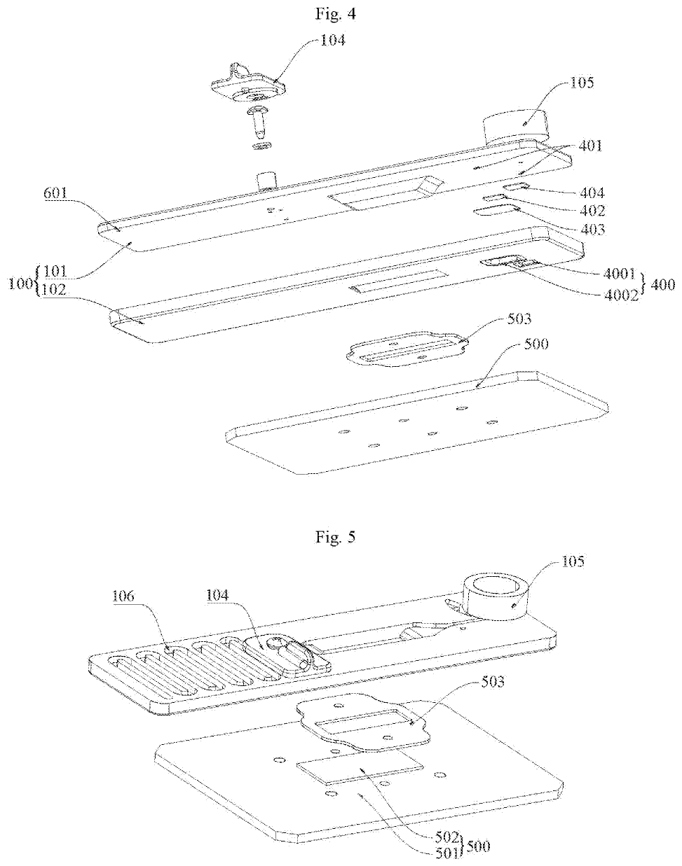

Further, as shown in FIG. 4, the sealed chamber 400 at least comprises a cavity A 4001 and a cavity B 4002 that are communicated with each other, and at least one liquid passing port 401 for feeding or discharging liquid is provided respectively above the cavity A 4001 and the cavity B 4002. When the liquid passing port 401 above the cavity A 4001 is used for feeding liquid, the liquid passing port 401 above the cavity B 4002 is used for discharging liquid; similarly, when the liquid passing port 401 above the cavity B 4002 is used for feeding liquid, the liquid passing port 401 above the cavity A 4001 is used for discharging liquid, and the two liquid passing ports 401 do not interfere with each other. The positions and forms of cavity A 4001 and cavity B 4002 can be arranged and provided according to detection needs.

Further, the conductive component 404 is provided at a bottom of the cavity A 4001 for transmitting electrical signals to the outside. In another embodiment, the conductive component 404 can adopt a metal sheet or an electrode.

Further, the flowing-through membrane 402 is provided at a top of the cavity B 4002, and a bottom of the cavity B 4002 is provided with the sealing component 403. The flowing-through membrane 402 is used to realize ion transmission or signal transmission in other forms between the liquid within the cavity B 4002 and the liquid within the liquid channel 201; the sealing component 403 is used to seal the bottom of the cavity B 4002 to prevent liquid from seeping out. In another embodiment, the sealing component 403 can adopt a sheet-like object.

Since the cavity A 4001 and the cavity B 4002 are communicated with each other and are closely spaced, the conductive component 404 is provided to the bottom of the cavity A 4001, and the flowing-through membrane 402 is provided to the top of the cavity B 4002, the conductive component 404 and the flowing-through membrane 402 can be wetted by liquids at the same location.

Further, the cavity A 4001 has a fusiform structure and is located on one side of the liquid channel 201, the cavity B 4002 is arranged below the liquid channel 201, and a tip of the cavity A 4001 opposite to the liquid channel 201 is communicated with the cavity B 4002. The cavity B 4002 is arranged below the liquid channel 201, the cavity B 4002 can realize signal transmission with the liquid channel 201 via the flowing-through membrane 402 provided to its top, that is, ion transmission or signal transmission in other forms between the liquid within the cavity B 4002 and the liquid within the liquid channel 201 can be realized via the flowing-through membrane 402, and the cavity A 4001 is communicated with the cavity B 4002, forming a sealed area as a whole.

It should be understood that the structures of cavity A 4001 and cavity B 4002 can be adjusted as needed. In this solution, the cavity A 4001 being provided as a fusiform structure is just one embodiment; in other embodiments, the cavity A 4001 can also be oval or in other forms. The cavity A 4001 and the cavity B 4002 are detachably arranged within the body 100, and whether to install the cavity A 4001 and the cavity B 4002, or considering installing only one of them, can be selected according to needs.

Further, a fluid storage device 105 is provided at the fluid input port 103 in a cooperation and communication manner, a top end of the fluid storage device 105 opens an opening, and a bottom end of the fluid storage device 105 is communicated with the fluid input port 103. Since the fluid input port 103 of the microfluidic device is usually small in size and it is inconvenient to add liquid directly through the fluid input port 103, in this solution, the fluid storage device 105 can be used as a liquid adding device with a larger top end opening, which facilitates the addition of liquid and makes the liquid not easy to spill out.

Further, the fluid storage device 105 is detachably provided to the body 100, and an interior of the fluid storage device 105 has a funnel-type structure. The fluid storage device 105 is detachably provided to the body 100 to facilitate installation, disassembly and replacement; in order to facilitate the liquid to fully enter the liquid channel 201, in this solution, the interior of the fluid storage device 105 is provided as a funnel-type structure, with a wider top and a narrower bottom, which facilitates filling the liquid and can avoid the liquid residue on the inner wall of the fluid storage device 105 as much as possible.

It should be noted that the fluid storage device 105 can be made into different shapes as needed, and the funnel-type structure described above is only one of preferred embodiments. The shape of the fluid input port 103 can also be adjusted according to actual needs, such as a round port, a square port, or a trumpet port, etc.

Further, an area on the body 100 corresponding to the position of the sensing area 301 is transparent, thereby facilitating observing the state of the liquid within the sensing area 301. The circle in FIG. 2 only refers to an approximate range of the sensing area 301, and the body 100 in this area can be made of transparent material, so as to visually observe the state of the liquid within the sensing area 301 and improve the sensing efficiency; the shape of the sensing area 301 is not limited and can be adjusted according to actual needs.

Further, the body 100 is also provided with the collection area 106 inside, the collection area 106 is communicated with a rear end of the liquid channel 201, and a liquid discharge port 601 is opened above the collection area 106. After the liquid within the liquid channel 201 is sensed, the on-off device 104 is opened so that the liquid within the liquid channel 201 can enter the collection area 106 to be collected, and when the volume of the liquid within the collection area 106 is greater than the volume of the collection area 106, the liquid can be discharged from the collection area 106 through the liquid discharge port 601, such as by using a syringe to draw the liquid from the liquid discharge port 601, so that the collection area 106 can continue to collect liquid to achieve a function of cyclic collection.

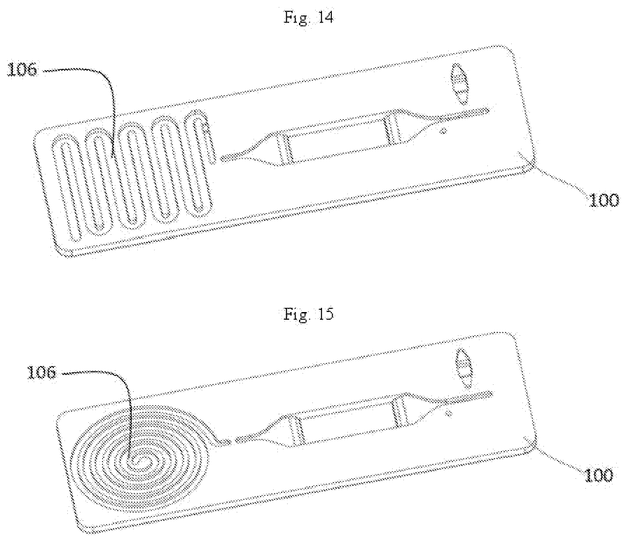

Further, as shown in FIGS. 14 and 15, the collection area 106 has a spiral or serpentine structure. The spiral or serpentine structure can effectively increase the volume of the collection area 106, facilitating the collection of more liquid.

It should be noted that the liquid collection area 106 can be in various forms, and can be a liquid storage pool or other storage media such as absorbent cotton, etc. The collection area 106 is not limited to a cavity structure.

Further, as shown in FIG. 4, the body 100 comprises an upper plate 101 and a lower plate 102 that are connected to each other, and the liquid channel 201 is a cavity formed between the upper plate 101 and the lower plate 102;
wherein a bottom of the liquid channel 201 is a portion of an upper surface of the lower plate 102, and a top of the liquid channel 201 is a portion of a lower surface of the upper plate 101. During specific use, the upper plate 101 and the lower plate 102 are permanently combined together by welding, gluing, bonding, etc., and the liquid channel 201 is formed by the special structures of the upper plate 101 and the lower plate 102, making full use of resources, and the structures of the upper plate 101 and the lower plate 102 also play an important role in the entire microfluidic device.

It should be understood that, in this solution, the part of the upper plate 101 within the sensing area 301 is made of transparent material.

Further, an area of the upper plate 101 corresponding to the position of the sensing area 301 is recessed toward the lower plate 102, that is, the thickness of the upper plate 101 at the sensing area 301 is reduced, facilitating observing the state of the liquid within the sensing area 301; an area of the lower plate 102 corresponding to the position of the sensing area 301 is hollowed-out, the form and size of the hollowed-out area can be adjusted as needed, and the hollowed-out area is used for external connection with a sensing device 500.

Further, an air vent 602 is also provided above the collection area 106. A negative pressure device can be externally connected at the air vent 602 to draw the liquid within the fluid storage device 105 into the liquid channel 201 and into the sensing area 301 by applying negative pressure.

It should be supplemented that the way for the liquid entering the liquid channel 201 from the fluid input port 103 can be: suction entering by applying negative pressure downstream; entering by applying external pressure; or fluid self-suction entering by expelling the air in the liquid channel 201 in advance to form a vacuum chamber.

Further, a control valve is provided between the fluid input port 103 and the fluid storage device 105, and the control valve is used to control whether the fluid input port 103 and the fluid storage device 105 are communicated. When the control valve is open, the fluid input port 103 is communicated with the fluid storage device 105, and at this time, liquid can be filled directly via the fluid storage device 105; when the control valve is closed, the fluid input port 103 is isolated from the fluid storage device 105, and the liquid cannot flow into the fluid input port 103.

As shown in FIG. 5, this application also provides a microfluidic detection device comprising a microfluidic device, and the microfluidic detection device further comprises:
a sensing device 500 connected to the body 100 and corresponding to the sensing area 301,
wherein the sensing device 500 has an overlapping portion with the liquid channel 201 and can allow the liquid within the liquid channel 201 to flow through it.

In this solution, the sensing device 500 corresponds to the hollowed-out position of the sensing area 301, and the sensing device 500 has an overlapping portion with the liquid channel 201, so the liquid located within the sensing area 301 can be sensed with the sensing device 500.

During use, the sensing device 500 is sealed and installed at the hollowed-out position of the sensing area 301 so that the liquid channel 201 there is in a sealed state, the sensing device 500 serves as a part of the liquid channel 201, and the liquid can be effectively sensed when it flows through the surface of the sensing device 500.

Further, a sealing element 503 is provided between the sensing device 500 and the body 100. The arrangement of the sealing element 503 enables the sensing area 301 to maintain a sealed state, which can not only effectively avoid liquid leakage at the connection between the sensing device 500 and the body 100, but also avoid the introduction of bubbles, improving the sensing efficiency.

Further, the sensing device 500 is detachably connected with the lower plate 102; and the sealing element 503 is detachably connected with the sensing device 500. Adopting a detachable connection way, such as by screws or buckles, etc., facilitates the installation and disassembly of the sensing device 500.

During specific installation, the sealing element 503 and the sensing device 500 can be connected together first, and then are installed to the lower plate 102 as a whole; or the sealing element 503 and the lower plate 102 can be connected together first, and then the sensing device 500 is connected to the sealing element 503.

Further, the sensing device 500 comprises a carrier plate 501 and a sensing chip 502 provided above the carrier plate 501, wherein the sensing chip 502 corresponds to the liquid channel 201 within the sensing area 301. During use, the liquid within the liquid channel 201 will flow through the upper surface of the sensing chip 502, and then be sensed by the sensing chip 502, wherein a metal probe is provided on the sensing chip 502, the metal probe is electrically connected to the conductive component 404, and the conductive component 404 then transmits the signal sensed by the sensing chip 502 to the outside. The metal probe can be in various forms, as long as it can be electrically connected to the conductive component 404, for example, it can be an electrode. The carrier plate 501 mainly plays the role of protecting and fixing the sensing chip 502, the carrier plate 501 can adopt a PCB plate, and the carrier plate 501 and the sensing chip 502 are combined to form the entire sensing device 500.

Further, the sealing element 503 is a sealing sheet, and a through hole is opened in the sealing sheet, wherein the liquid channel 201 and the sensing chip 502 are communicated via the through hole. A through hole is opened in the sealing sheet, and liquid can flow into the through hole and reach the surface of the sensing chip 502 to be sensed, wherein the sensing area 301 can be effectively sealed by the sealing sheet to avoid leakage and the introduction of bubbles.

Further, a cross-sectional area of the through hole is smaller than an upper surface area of the sensing chip 502, and edges of the through hole are located above the sensing chip 502. It is ensured that the through hole is completely located above the sensing chip 502, that is, the liquid within the through hole only contacts the upper surface of the sensing chip 502 and can be fully sensed.

In another preferred embodiment, the sealing sheet and the sensing device 500 are installed to the lower plate 102 at the hollowed-out position of the sensing area with bolts 1041 first, the rotary valve is adjusted to make the liquid channel 201 and the flow channel in an interrupted state, then the control valve at the fluid input port 103 is opened, liquid is filled via the fluid storage device 105 to make the liquid enter into the liquid channel 201, the liquid within the sensing area 301 is continuously and stably sensed with the sensing chip 502 of the sensing device 500, the rotary valve is adjusted to make the liquid channel 201 and the flow channel in a communicated state after the sensing is completed, and the sensed liquid immediately flows into the collection area 106, and when there is too much liquid within the collection area 106, it can be discharged via the liquid discharge port 601 in time.

As shown in FIG. 5, in yet another preferred embodiment, the fluid storage device 105 has a cylindrical structure, the on-off device 104 adopts a rotary valve, the rotary valve is provided to the upper surface of the upper plate 101, close to the inlet of the collection area 106 and located on one side of the liquid channel, and the collection area 106 is a serpentine flow channel. The part of the upper plate 101 within the sensing area 301 is recessed inward to form a fusiform groove or a rectangular groove. The sealing element 503 is a butterfly-shaped sealing sheet, the two wings of the sealing sheet are connected to the carrier plate 501 by bolts, the material of the sealing sheet is not specifically limited here, and when selecting the material of the sealing sheet, its sealing performance should be the main consideration. The sensing chip 502 and the carrier plate 501 are both a rectangular sheet-plate-like structure, and the sensing chip 502 is fixed in the middle of the carrier plate 501, and three pairs of threaded holes are symmetrically arranged around edges of the sensing chip 502 on the carrier plate 501, wherein one pair of threaded holes at the middle are used to fix the sealing element 503, and the remaining threaded holes are used for a bolt connection to the lower plate 102 so as to fix the carrier plate 501.

Screw through holes are opened both on the upper plate 101 and the lower plate 102 at positions corresponding to the remaining two pairs of threaded holes. During specific installation, the bolts pass through the screw holes of the upper plate 101 and the lower plate 102 in sequence, then are tightly screwed with the remaining two pairs of threaded holes on the carrier plate 501, and the installation and fixation of the sensing device 500 are completed.

As shown in FIGS. 8-13, in another preferred embodiment, the rotary valve has a rectangular structure, which is fixed to the upper surface of the upper plate 101 by bolts, two opening holes are provided through the upper plate 101 below the rotary valve, the opening of the flow channel is located on the surface of the rotary valve that is in contact with the upper plate 101, and the directions indicated by arrows in the figures are the flow directions of liquid. When the rotary valve is in the “OFF” state, the bottom of the rotary valve will close the two opening holes, causing the liquid channel 201 to be interrupted from the flow channel, that is, the liquid channel 201 is not communicated with the collection area 106, and at this time, continuous and stable sensing can be performed; when the rotary valve is in the “ON” state, the flow channel at the bottom of the rotary valve will be communicated with the two opening holes correspondingly, causing the liquid channel 201 to be communicated with the flow channel, that is, the liquid channel 201 is communicated with the collection area 106, and at this time, liquid can enter the collection area 106 to be collected.

Although the embodiments of this application have been shown and described above, it can be understood that the above embodiments are exemplary and should not be construed as limitations of this application, and ordinary persons skilled in the art can make changes, modifications, substitutions and variations to the above embodiments within the scope of this application.

1. A microfluidic device, comprising a body and a liquid channel provided within the body;
wherein a sensing area is provided on the body;
wherein a fluid input port communicated with the liquid channel is also provided on the body, and an arrangement position of the fluid input port does not include the sensing area.

2. The microfluidic device according to claim 1, wherein, the body is also provided with an on-off device, and the on-off device is used to control flow and interruption of liquid within the liquid channel.

3. The microfluidic device according to claim 2, wherein, a flow channel which can be communicated with the liquid channel is provided within the on-off device; the on-off device controls whether the flow channel and the liquid channel are communicated with each other by moving relative to the body.

4. The microfluidic device according to claim 3, wherein, at least one hollow sealed chamber is also provided within the body, and a top of at least one sealed chamber is provided with a flowing-through membrane, and the sealed chamber and the liquid channel share the flowing-through membrane.

5. The microfluidic device according to claim 4, wherein, at least one liquid passing port is also provided on the body, and the liquid passing port is communicated with the sealed chamber.

6. The microfluidic device according to claim 5, wherein, a bottom of the sealed chamber is provided with a sealing component or a conductive component, and the conductive component is used to transmit electrical signals.

7. The microfluidic device according to claim 6, wherein, the sealed chamber at least comprises a cavity A and a cavity B that are communicated with each other, and at least one liquid passing port for feeding or discharging liquid is provided respectively above the cavity A and the cavity B.

8. The microfluidic device according to claim 7, wherein, the conductive component is provided at a bottom of the cavity A.

9. The microfluidic device according to claim 8, wherein, the flowing-through membrane is provided at a top of the cavity B, and a bottom of the cavity B is provided with the sealing component.

10. The microfluidic device according to claim 7, wherein, the cavity A has a fusiform structure and is located on one side of the liquid channel, the cavity B is arranged below the liquid channel, and a tip of the cavity A opposite to the liquid channel is communicated with the cavity B.

11. The microfluidic device according to claim 1, wherein, a fluid storage device is provided at the fluid input port in a cooperation and communication manner, a top end of the fluid storage device opens an opening, and a bottom end of the fluid storage device is communicated with the fluid input port.

12. (canceled)

13. (canceled)

14. The microfluidic device according to claim 1, wherein, the body is also provided with a collection area inside, the collection area is communicated with a rear end of the liquid channel, and a liquid discharge port is opened above the collection area.

15. (canceled)

16. The microfluidic device according to claim 1, wherein, the body comprises an upper plate and a lower plate that are connected to each other, and the liquid channel is a cavity formed between the upper plate and the lower plate,
wherein a bottom of the liquid channel is a portion of an upper surface of the lower plate, and a top of the liquid channel is a portion of a lower surface of the upper plate.

17. The microfluidic device according to claim 16, wherein, an area of the upper plate corresponding to the position of the sensing area is recessed toward the lower plate; an area of the lower plate corresponding to the position of the sensing area is hollowed-out.

18. The microfluidic device according to claim 14, wherein, an air vent is also provided above the collection area.

19. The microfluidic device according to claim 11, wherein, a control valve is provided between the fluid input port and the fluid storage device, and the control valve is used to control whether the fluid input port and the fluid storage device are communicated.

20. A microfluidic detection device comprising the microfluidic device according to claim 1, further comprising:
a sensing device connected to the body and corresponding to the sensing area,
wherein the sensing device has an overlapping portion with the liquid channel and can allow the liquid within the liquid channel to flow through it.

21. The microfluidic detection device according to claim 20, wherein, a sealing element is provided between the sensing device and the body;
the sensing device is detachably connected with the lower plate; the sealing element is detachably connected with the sensing device.

22. (canceled)

23. The microfluidic detection device according to claim 21, wherein, the sensing device comprises a carrier plate, and
a sensing chip provided above the carrier plate, wherein the sensing chip corresponds to the liquid channel within the sensing area.

24. The microfluidic detection device according to claim 23, wherein, the sealing element is a sealing sheet, and a through hole is opened in the sealing sheet, wherein the liquid channel and the sensing chip are communicated via the through hole.

25. (canceled)
